(19) United States
(12) Patent Application Publication
(10) Pub. No.: US 2026/0066985 A1
(43) Pub. Date: Mar. 5, 2026

(54) COMMUNICATION MANAGEMENT METHOD AND APPARATUS

(71) Applicant: BEIJING XIAOMI MOBILE SOFTWARE CO., LTD., Beijing (CN)

(72) Inventors: Yuxin MAO, Beijing (CN); Jinhua WU, Beijing (CN)

(73) Assignee: BEIJING XIAOMI MOBILE SOFTWARE CO., LTD., Beijing (CN)

(21) Appl. No.: 19/110,512

(22) PCT Filed: Sep. 29, 2022
(86) PCT No.: PCT/CN2022/122748

§ 371 Date: Mar. 11, 2025

(30) Foreign Application Priority Data
Sep. 20, 2022 (WO) PCT/CN2022/119992

(51) Int. Cl. H04B 7/185

(52) U.S. Cl. CPC H04B 7/18513

(57) ABSTRACT

A communication management method, performed by a server, includes: sending an information update to a first network element, wherein the information update comprises at least one of satellite coverage information or a communication parameter for at least one user equipment (UE), wherein the communication parameter comprises at least one of movement information of the UE or a battery level, and at least one of the satellite coverage information or the communication parameter is configured to assist a network in performing communication management on the UE.

### CROSS REFERENCE TO RELATED APPLICATIONS

The present application is a National Stage of International Application No. PCT/CN2022/122748, filed on Sep. 29, 2022, which claims priority to PCT patent application No. PCT/CN2022/119992, filed on Sep. 20, 2022, both of which are incorporated by reference herein in their entireties for all purposes.

### TECHNICAL FIELD

The disclosure relates to the field of mobile communication technology, in particular to a communication management method and an apparatus.

### BACKGROUND

In a mobile network communication system, an information interaction between a third-party server and a core network can be achieved through a service capability exposure function (SCEF), so that the core network can obtain information used for communication management and control for a user equipment (UE). Currently, in the related art, the information provided by the third-party server to the core network through the SCEF includes: a periodic communication indication (used to identify the user's requirement for continuous or periodic communication), a communication duration (used to indicate the duration of periodic communication), a periodic interval (used to specify the time interval of the periodic communication), a scheduled communication time (used to specify the time when the UE is available for communication), a UE state indication (used to indicate whether the UE is in a stationary or mobile state), a battery capacity indication (used to identify whether it is powered by a non-rechargeable/non-replaceable battery or a rechargeable/replaceable battery, or it is not powered by a battery), and a transmission characteristic (used to identify a data transmission type, including single-packet transmission, dual-packet transmission, or multi-packet transmission). The existing technology takes into account information such as the behavior of UE intermittent communication, terminal battery capacities, and service characteristics. However, in actual communication, there is still requirements for communication management and control that incorporates other terminal information. For example, there is a requirement for communication control based on a UE moving trajectory and satellite signal coverage information. As a UE moves through areas with no signal coverage for a long time (for example, tunnels or when using a satellite access with discontinuous coverage during a period without signal coverage), the network can cache the communication date of the UE during the period without signal coverage. Another example is a requirement for communication control based on a UE battery level, the network obtains the UE battery level, and starts a power-saving mechanism for the UE accordingly, and sets power-saving parameters.

For the above requirements, the existing processes and capability parameters do not yet support the provision of UE moving trajectory, satellite access signal coverage information or battery level capacity information, and thus the network cannot perform the communication management and control according to the UE moving trajectory, the access signal coverage information or the battery level.

### SUMMARY

According to a first aspect of embodiments of the disclosure, a communication management method is provided. The method is performed by a server, and includes: sending an information update to a first network element, in which the information update includes satellite coverage information and/or a communication parameter for at least one UE, the communication parameter at least one of movement information of the UE or a battery level, and the satellite coverage information and/or the communication parameter is configured to assist a network in performing communication management on the UE.

According to a second aspect of embodiments of the disclosure, a communication management method is provided. The method is performed by a first network element, and includes: receiving an information update sent by a server, in which the information update includes satellite coverage information and/or a communication parameter for at least one UE, and the communication parameter includes at least one of movement information of the UE or a battery level; and sending the information update to a second network element, in which the satellite coverage information and/or the communication parameter is configured to assist a network in performing communication management on the UE.

According to a third aspect of embodiments of the disclosure, a communication management method is provided. The method is performed by a second network element, and includes: receiving an information update sent by a first network element, in which the information update includes satellite coverage information and/or a communication parameter for at least one UE, and the communication parameter includes at least one of movement information of the UE or a battery level; and performing communication management on the UE based on the satellite coverage information and/or the communication parameter.

According to a fourth aspect of embodiments of the disclosure, a communication apparatus is provided. The communication apparatus includes: a processor and a memory for storing a computer program, when the processor executes the computer program, the processor is configured to implement the communication management method in the embodiment of the first aspect, the embodiment of the second aspect or the embodiment of the third aspect.

According to a fifth aspect of embodiments of the disclosure, a non-transitory computer-readable storage medium is provided. The non-transitory computer-readable storage medium stores computer-executable instructions, and when the computer-executable instructions are executed by a processor, the communication management method in the embodiment of the first aspect, the embodiment of the second aspect or the embodiment of the third aspect is implemented.

### BRIEF DESCRIPTION OF THE DRAWINGS

The above-mentioned and/or additional aspects and advantages of the disclosure will be apparent and easily understood from the following description of embodiments taken in combination with the accompanying drawings, in which:

FIG. 1 is a flowchart of a communication management method according to an embodiment of the disclosure.

FIG. 2 is a flowchart of a communication management method according to an embodiment of the disclosure.

FIG. 3 is a flowchart of a communication management method according to an embodiment of the disclosure.

FIG. 4 is a flowchart of a communication management method according to an embodiment of the disclosure.

FIG. 5 is a flowchart of a communication management method according to an of the disclosure.

FIG. 6 is a flowchart of a communication management method according to an embodiment of the disclosure.

FIG. 7 is an interaction schematic diagram of a communication management method according to an embodiment of the disclosure.

FIG. 8 is an interaction schematic diagram of a communication management method according to an embodiment of the disclosure.

FIG. 9 is a block diagram of a communication management apparatus according to an embodiment of the disclosure.

FIG. 10 is a block diagram of a communication management apparatus according to an embodiment of the disclosure.

FIG. 11 is a block diagram of a communication management apparatus according to an embodiment of the disclosure.

FIG. 12 is a block diagram of a communication management apparatus according to an embodiment of the disclosure.

FIG. 13 is a block diagram of a communication management apparatus according to an embodiment of the disclosure.

FIG. 14 is a block diagram of a communication apparatus according to an embodiment of the disclosure.

FIG. 15 is a schematic diagram of a chip according to an embodiment of the disclosure.

### DETAILED DESCRIPTION

The embodiments of the disclosure will be described in detail, examples of which are illustrated in the accompanying drawings, in which the same or similar numbers indicate the same or similar elements or elements having the same or similar functions throughout. The embodiments described below with reference to the accompanying drawings are exemplary and are intended to explain the disclosure, and should not be construed as limiting the disclosure.

In a mobile network communication system, an information interaction between a third-party server and a core network may be achieved through a service capability exposure function (SCEF), so that the core network can obtain information used for communication management and control for a user equipment (UE). In a typical scenario, the third-party server provides information, such as a communication parameter, a network parameter configuration, a service parameter configuration, etc., to the core network through the SCEF network element, so that the core network can perform communication management and control on the UE based on the provided information. For example, the third-party server provides the network with a maximum latency, a maximum response time, and a recommended number of downlink packets through the SCEF network element. Based on these parameters, the network determines a power saving mechanism (PSM), an extended discontinuous reception (eDRX), and a data cache configuration, etc. Based on an operator policy, the SCEF network element or a Home Subscriber Server (HSS) may accept, reject or modify the provided parameters, and indicate the third-party server to accept, reject or modify the provided parameters.

The existing related art takes into account information such as the behavior of UE intermittent communication, terminal battery capacities, and service characteristics by defining information such as a periodic interval and a battery capacity indication. However, in actual communication, there is still requirements for communication management and control that incorporates other terminal information and incorporates satellite coverage information in satellite communication scenarios. For example, there is a requirement for communication control based on a UE moving trajectory. As a UE moves through areas with no signal coverage for a long time (for example, tunnels or when using a satellite access with discontinuous coverage during a period without signal coverage), the network can cache the communication date of the UE during the period without signal coverage. Another example is a requirement for communication control based on a UE battery level, the network obtains the UE battery level, and starts a PSM for the UE accordingly, and sets power-saving parameters.

For the above requirements, the existing processes and capability parameters do not yet support the provision of satellite access signal coverage information, UE moving trajectory, or battery level capacity information, and thus the network cannot perform the communication management and control according to the satellite access signal coverage information, the UE moving trajectory, or the battery level.

The disclosure proposes a communication management method and apparatus. An application server (AS) is enabled to provide satellite coverage information, UE movement information or a UE battery level to a core network through an SCEF, and the network is enabled to perform communication management and control on the UE based on those information, for example, configuring data cache when the UE is out of coverage, or indicating the UE to enter a PSM when the battery level is lower than a threshold or the UE enters a period without satellite coverage. The scheme provided by the disclosure further improves a flexibility of communication control of the UE.

The communication management method and apparatus according to the disclosure will be introduced in detail below in combination with the attached drawings.

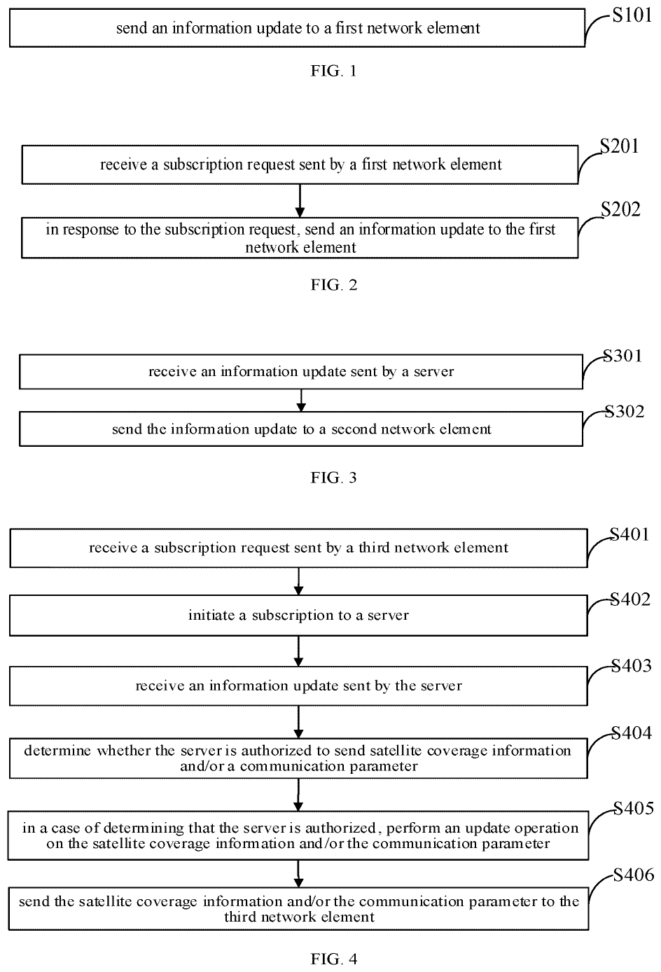

FIG. 1 is a flowchart of a communication management method according to an embodiment of the disclosure. The method is performed by a server. In detail, the server may be a third-party AS, a service capability server (SCS), a satellite network management center, etc. In the disclosure, the server is, for example, an AS, which it is not limited herein. As illustrated in FIG. 1, the method may include the following steps.

At step S101, an information update is sent to a first network element.

In the embodiment of the disclosure, the information update includes satellite coverage information and/or a communication parameter for at least one UE. The communication parameter includes at least one of movement information of the UE or a battery level, and the communication parameter is configured to assist a network in performing communication management on the UE.

It should be understood that the information update may be a user information update request, which is configured to enable the network to perform the communication management and control on the UE according to the relevant user information. In detail, the communication parameter for the UE included in the information update includes the movement information of the UE and/or the battery level. The movement information may be a UE movement-related parameter, and the battery level may be a parameter related to the UE battery level. The satellite coverage information included in the information update may be at least one of ephemeris information of a satellite access network, satellite trajectory information or satellite coverage information of a UE location.

In the disclosure, the server may send the information update to the first network element autonomously or in response to a subscription of the network, which is not limited in this disclosure.

In the disclosure, the first network element may be an SCEF, and other possible network elements are not enumerated here.

In conclusion, according to the communication management method provided by this disclosure, the server sends the information update to the first network element. The information update includes the satellite coverage information and/or the communication parameter for at least one UE. The communication parameter includes at least one of the movement information of the UE or the battery level, and the communication parameter is configured to assist the network in performing the communication management on the UE. Through the scheme disclosed in the disclosure, the AS is enabled to provide the satellite coverage information, the UE movement information or the UE battery level to the core network through the SCEF, so that the network may perform the communication management and control on the UE based on those information, thus improving a flexibility of communication control of the UE.

FIG. 2 is a flowchart of a communication management method according to an embodiment of the disclosure. The method is performed by a server. Based on the embodiment of FIG. 1, as illustrated in FIG. 2, the method includes the following steps.

At step S201, a subscription request sent by a first network element is received.

In the embodiment of the disclosure, a network sends the subscription request to the server to subscribe to relevant information of the UE. In a specific example, the first network element may subscribe to a communication parameter for one UE or a group of UEs from the server. For example, the first network element may subscribe to at least one of satellite coverage information, movement information of the UE and a battery level, to perform communication management on the one UE or the group of UEs.

At step S202, in response to the subscription request, an information update is sent to the first network element.

In this embodiment, the server sends the information update to the first network element in response to the subscription of the network. The information update includes satellite coverage information and/or a communication parameter for at least one UE. The communication parameter includes at least one of movement information of the UE or a battery level, and the communication parameter is configured to assist the network in performing the communication management on the UE.

In some optional embodiments of the disclosure, the information update further includes validity time information, which is configured for indicating a validity time of at least one of the satellite coverage information, the movement information or the battery level. The validity time may assist the network in performing an information update operation, for example, deleting relevant information after the validity time expiring.

In some optional embodiments of the disclosure, the information update includes satellite coverage information and/or communication parameter sets for a plurality of UEs. In other words, the network in this disclosure may perform the communication management and control on one UE or a group of UEs by the obtained information update. It should be understood that for only one UE, the communication parameter corresponding to the UE may constitute a communication parameter set. For a plurality of UEs, the communication parameter of each UE may constitute a corresponding communication parameter set, respectively, i.e. a plurality of communication parameter sets may be constituted.

In some optional embodiments of the disclosure, the movement information of the UE includes at least one of: a moving trajectory of the UE; a moving velocity of the UE; or a time when the UE is at a certain location on a moving trajectory.

In some optional embodiments of the disclosure, the satellite coverage information includes at least one of: ephemeris information and/or satellite trajectory information of a satellite access network, in which the satellite access network includes an available satellite access network or a satellite access network used currently by the UE; or satellite coverage information of a UE location, in which the satellite coverage information indicates satellite signal coverage information of the UE location, the satellite signal coverage information includes at least one of a signal coverage time, a signal coverage duration, a time without signal coverage or a duration without signal coverage, and the UE location includes a current location of the UE or a location of the UE on a moving trajectory.

The signal coverage time may be understood as a starting moment when a satellite signal coverage is present, and the signal coverage duration may be understood as a duration that the satellite signal coverage continues to exist from the starting moment. The time without signal coverage may be understood as a starting moment when the UE loses the satellite signal coverage, and the duration without signal coverage may be understood as a duration that the satellite signal coverage is continuously absent from the starting moment.

In other words, there are three possible types of the satellite coverage information in the disclosure, which include:
1) the ephemeris information and/or the satellite trajectory information of the satellite access network, through which it indicates the ephemeris information and/or the satellite trajectory information of the available satellite access network or the satellite access network currently used by the UE;
2) the satellite coverage information of the current location of the UE, through which it indicates the satellite signal coverage information of the current location of the UE, including at least one of the signal coverage time, the signal coverage duration, the time without signal coverage or the duration without signal coverage; and
3) the satellite coverage information of one or more UE locations on the moving trajectory, through which it indicates the satellite signal coverage information of possible key UE locations on the moving trajectory, including at least one of the signal coverage time, the signal coverage duration, the time without signal coverage or the duration without signal coverage.

In a specific example, the information update message sent by the SCS/AS to the SCEF also includes a network external identifier of a user, a mobile subscriber integrated service digital number (MSISDN) or a network external identifier of a user group, a SCS/AS identifier and a communication parameter (set) ID, etc.

In the embodiment of the disclosure, the information update may also include one or more of: a periodic communication indication (used to identify the user's requirement for continuous or periodic communication), a communication duration (used to indicate the duration of periodic communication), a periodic interval (used to specify the time interval of the periodic communication), a scheduled communication time (used to specify the time when the UE is available for communication), a UE state indication (used to indicate whether the UE is in a stationary or mobile state), a battery capacity indication (used to identify whether it is powered by a non-rechargeable/non-replaceable battery or a rechargeable/replaceable battery, or it is not powered by a battery), and a transmission characteristic (used to identify a data transmission type, including single-packet transmission, dual-packet transmission, or multi-packet transmission), which is not limited in the disclosure.

In conclusion, according to the communication management method provided by this disclosure, the server may sending the information update to the first network element in response to the subscription of the first network element. The information update includes the satellite coverage information and/or the communication parameter for at least one UE. The communication parameter includes at least one of movement information of the UE or the battery level, and the communication parameter is configured to assist the network in performing the communication management on the UE. Through the scheme in this disclosure, the AS is enabled to, in response to the subscription of the network, provide the satellite coverage information, the UE movement information or the UE battery level to the core network through the SCEF, and the network performs the communication management and control on the UE based on those information, thus improving a flexibility of communication control of the UE

FIG. 3 is a flowchart of a communication management method according to an embodiment of the disclosure. The method is performed by a first network element. Specifically, the first network element may be an SCEF network element. As illustrated in FIG. 3, the method includes the following steps.

At step S301, an information update sent by a server is received.

In the embodiment of the disclosure, the information update includes satellite coverage information and/or a communication parameter for at least one UE, and the communication parameter includes at least one of movement information of the UE or a battery level.

At step S302, the information update is sent to a second network element.

In the embodiment of the disclosure, the satellite coverage information and/or the communication parameter is configured to assist the network in performing communication management on the UE.

In the embodiment of the disclosure, the second network element may be a mobility management entity (MME), which, as a key control node of a core network, may manage users by interacting with the HSS. It is understood that in this disclosure, the SCEF network element may send the information update to the MME through the HSS.

Corresponding to the embodiment shown in FIG. 1, the first network element receives the information update provided by the server and sends the information update to the second network element through a third network element, to assist the network (for example, the second network element) to perform the communication management and control on the UE based on the information update.

In conclusion, according to the communication management method provided by this disclosure, the first network element may receive the information update sent by the server, and sends the information update to the second network element. The information update includes the satellite coverage information and/or the communication parameter for at least one UE. The communication parameter includes at least one of the movement information of the UE or the battery level, and the satellite coverage information and/or the communication parameter may be configured to assist the network in performing the communication management on the UE. The network thus is enabled to perform the communication manage and control on the UE based on the information provided by the AS. Through the scheme in this disclosure, the AS is enabled to provide the satellite coverage information, the UE movement information or the UE battery level to the core network through the SCEF, and the network performs the communication management and control on the UE based on those information, thus improving a flexibility of communication control of the UE.

FIG. 4 is a flowchart of a communication management method according to an embodiment of the disclosure. The method is performed by a first network element. Based on the embodiment of FIG. 3, as illustrated in FIG. 4, the method includes the following steps.

At step S401, a subscription request sent by a third network element is received.

In the embodiment of the disclosure, the third network element may be a HSS. The first network element receives the subscription request from the third network element. The subscription request is configured to subscribe to information update parameters, such as satellite coverage information and/or communication parameter. In detail, the information update includes satellite coverage information and/or a communication parameter for at least one UE, and the communication parameter includes at least one of movement information of the UE or a battery level.

At step S402, the subscription request is initiated to a server.

In the embodiment of the disclosure, the first network element may initiate a subscription to the server after receiving the subscription request sent by the third network element, so as to subscribe to data required by the network from the server. The third network element may receive a subscription initiated by a second network element.

It is understood that the above steps S401-S402 are optional steps, which means that the first network element may directly receive the information update sent by the server autonomously without having to respond to the subscription of the network. In addition, the first network element may accept the subscription of the third network element, but there is no restriction on how the first network element obtains subscribed parameters. In other words, the Version first network element may initiate the subscription to the server or receive related parameters sent by the first network element autonomously.

At step S403, an information update sent by the server is received.

In response to the subscription request initiated by the network, the server may send the information update to the first network element, and the first network element receives the information update. In the embodiment of the disclosure, the information update includes satellite coverage information and/or a communication parameter for at least one UE, and the communication parameter includes at least one of movement information of the UE or a battery level.

In an optional embodiment, after receiving the subscription request sent by the third network element, the first network element receives the information update sent by the server, in which the information update may be sent by the server automatically or subscribed by the first network element to the server, which is not limited herein.

At step S404, it is determined whether the server is authorized to send satellite coverage information and/or a communication parameter.

In the embodiment of the disclosure, after receiving the information update and before providing the information update to the third network element, the first network element may identify the server that sends the information update in order to determine whether the server is authorized to send related parameters.

Specifically, the SCEF network element may check whether the AS or the SCS is authorized to send satellite coverage information and/or communication parameter update request to the UE or each UE in a group of UEs, where an authentication method may be executed with reference to relevant standards, and will not be repeated here.

At step S405, in response to determining that the server is authorized to send the satellite coverage information and/or the communication parameter, an update operation is performed on the satellite coverage information and/or the communication parameter, in which the update operation includes at least one of an adding operation, a modifying operation or a deleting operation.

In the embodiment of the disclosure, when it is determined that the AS is authorized to send the satellite coverage information and/or the communication parameter, the SCEF may perform the update operation according to an operator policy or a configuration, for example, adding, modifying or deleting the satellite coverage information and/or the communication parameter.

At step S406, the satellite coverage information and/or the communication parameter may be sent to the third network element, and the third network element provides the satellite coverage information and/or the communication parameter to a second network element.

In the embodiment of the disclosure, the third network element may be a HSS. The SCEF may send the satellite coverage information and/or the communication parameter to the HSS, and then the HSS will send the satellite coverage information and/or the communication parameter to the MME, to assist the MME in performing the communication management on the UE.

In some optional embodiments of the disclosure, the information update message sent by the SCS/AS to the SCEF also includes a network external identifier of a user, a MSISDN or a network external identifier of a user group, an SCS/AS identifier, a communication parameter (set) identifier, etc. The SCEF generates a corresponding SCEF reference ID for the communication parameter set sent to the HSS according to the communication parameter set identifier obtained from the SCS/AS. The SCEF sends the satellite coverage information and/or communication parameter update message to the HSS, including the network external identifier of the user, the MSISDN, the network external identifier of the user group, the SCEF reference ID, an SCEF address, the communication parameter set, a valid time, etc.

In conclusion, according to the communication management method provided by the disclosure, the first network element receives the information update sent by the server in response to the subscription of the network and authenticates the server. The server sends the information update to the first network element, and the first network element sends the information update to the second network element through the third network element. The information update includes the satellite coverage information and/or the communication parameter for at least one UE. The communication parameter includes at least one of the movement information of the UE or the battery level, and the satellite coverage information and/or the communication parameter may be configured to assist the network in performing the communication management on the UE, thus the network may perform the communication management and control on the UE based on the information provided by the server. Through the scheme in this disclosure, the AS is enabled to provide the satellite coverage information, the UE movement information or the UE battery level to the core network through the SCEF, and the network performs the communication management and control on the UE based on those information, thus improving a flexibility of communication control of the UE.

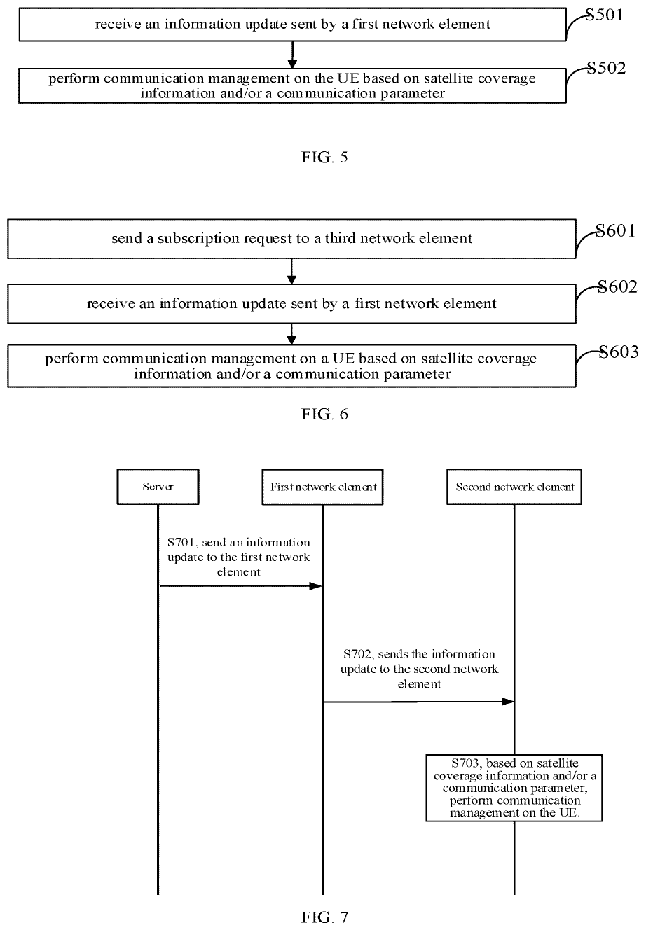

FIG. 5 is a flowchart of a communication management method according to an embodiment of the disclosure. The method is performed by a second network element. The second network element may be an MME in the embodiment of the disclosure. As illustrated in FIG. 5, the method includes the following steps.

At step S501, an information update sent by a first network element is received.

In the disclosure, the information update includes satellite coverage information and/or a communication parameter for at least one UE, and the communication parameter includes at least one of movement information of the UE or a battery level.

It is understood that in the disclosure, the second network element MME receives the information update from the first network element SCEF through the third network element HSS.

At step S502, communication management is performed on the UE based on the satellite coverage information and/or the communication parameter.

Corresponding to the embodiments shown in FIGS. 1 and 3, the first network element receives the information update from the server and then sends the information update to the second network element through the third network element, so that the second network element may perform the communication management and control on the UE based on the information obtained from the server.

In conclusion, according to the communication management method provided by the disclosure, the second network element receives the information update from the first network element and performs the communication management on the UE based on the information update. The information update includes the satellite coverage information and/or the communication parameter for at least one UE, and the communication parameter includes at least one of the movement information of the UE or the battery level. Thus, the network may perform the communication management and control on the UE based on the information obtained from the server. Through the scheme in this disclosure, the AS is enabled to provide the satellite coverage information, the UE movement information or the UE battery level to the core network through the SCEF, and the network performs the communication management and control on the UE based on those information, thus improving a flexibility of communication control of the UE.

FIG. 6 is a flowchart of a communication management method according to an embodiment of the disclosure. Based on the embodiment of FIG. 5, as illustrated in FIG. 6, the method includes the following steps.

At step S601, a subscription request is sent to a third network element, in which the subscription request is configured for subscribing to satellite coverage information and/or a communication parameter.

It is understood that the second network element may subscribe to an information update from the third network element. The third network element may obtain the information update after receiving the subscription of the second network element. The information update may be initiated by a first network element automatically, and sent to the third network element by the first network element, or the information update may be subscribed by the third network element from the first network element, which is not limited in the disclosure. The above step S601 is an optional step, which means that the third network element sends the information update to the second network element actively without the subscription of the network.

At step S602, an information update sent by a first network element is received.

In the disclosure, the information update includes the satellite coverage information and/or the communication parameter for at least one UE, and the communication parameter includes at least one of movement information of the UE or a battery level.

In an implementation, the second network element may receive the satellite coverage information and/or the communication parameter from the third network element HSS, and the satellite coverage information and/or the communication parameter is received by the third network element HSS from the first network element SCEF.

At step S603, communication management is performed on the UE based on the satellite coverage information and/or the communication parameter.

Specifically, the MME may store the satellite coverage information and/or a communication parameter set (and a related SCEF reference ID and a valid time), and perform the communication management according to the satellite coverage information and/or the communication parameter set.

In an optional embodiment of the disclosure, when the communication parameter include the movement information, step S603 includes: in a case of the UE using satellite access with discontinuous coverage, providing the satellite coverage information for the UE; and/or, in a case of the UE being out of coverage, determining that the UE remains in no service or indicating the UE to use other available access.

Specifically, when the UE uses the satellite access with discontinuous coverage, the MME may provide the satellite coverage information for the UE. When the UE is out of coverage, it is determined that the UE remains in no service or the UE is indicated to use other available access.

In an optional embodiment of the disclosure, when the communication parameter includes the battery level, step S603 includes: determining that the UE enters a power saving mode or indicating the UE to use other available access; and in a case of the battery level being lower than a threshold or the UE entering a period without satellite coverage, indicating the UE to enter the power saving mode.

Specifically, the MME sets a power saving mode parameter (such as a PSM parameter or an eDRX parameter) according to the communication parameter and instructs the UE to execute the corresponding power saving mode.

In some optional embodiments of the disclosure, the second network element MME may determine a communication parameter set to be modified through a process where an SCEF reference identifier associated with the communication parameter set matches an SCEF reference ID of the communication parameter set stored in the UE. When the MME determines to modify the existing stored communication parameter set, the MME discards the stored communication parameter set, and stores the received communication parameter set together with the associated valid time in a context of the UE under the same SCEF reference ID.

In an optional implementation, the second network element may update (add, delete or modify) the received satellite coverage information and/or the communication parameter.

For example, the information update also includes validity time information corresponding to the satellite coverage information and/or the communication parameter, and the validity time information is configured to indicate a validity time of at least one of the satellite coverage information, the movement information or the battery level. The method further includes: in a case of the validity time expiring, automatically deleting the corresponding satellite coverage information and/or the communication parameter.

Specifically, when the satellite coverage information and/or the communication parameter set need to be deleted, the MME may delete the satellite coverage information and/or the communication parameter set from the subscription. When the validity time(s) of the satellite coverage information and/or the communication parameter set stored in the MME expire(s), the MME may automatically delete the associated satellite coverage information and/or the communication parameter set with no additional signaling.

In some optional implementations, the following description is made about the third network element HSS.

The third network element HSS checks the satellite coverage information and/or the communication parameter update request message, for example, checking whether a network external identifier of a user, a MSISDN or a network external identifier of a user group exists. In a case where the checking fails, the HSS sends an update failure message to the SCEF. The HSS performs a conversion between the network external identifier of the user or the MSISDN with an international mobile subscriber identity (IMSI), or resolves the network external identifier of the user group into an IMSI of an in-group user and stores the satellite coverage information and/or the communication parameter set and its validity time in subscription data of the UE corresponding to the IMSI, so that when the UE moves and the serving MME may change, the satellite coverage information and/or the communication parameter may be sent to the latest serving MME.

In conclusion, according to the communication management method provided by the disclosure, the second network element may perform a parameter subscription to the third network element, and the third network element may also subscribe to the first network element through a subscription mode. The first network element subscribes to the server to obtain an update of subscribed parameters and provides the update to the second network element, so that the second network element may perform the communication management on the UE based on the information update. The information update includes the satellite coverage information and/or the communication parameter for at least one UE, and the communication parameter includes at least one of movement information of the UE and a battery level. The network may thus realize the communication management and control for the UE based on the information update. Through the scheme in this disclosure, the AS is enabled to provide the satellite coverage information, the UE movement information or the UE battery level to the core network through the SCEF, and the network performs the communication management and control on the UE based on those information, thus improving a flexibility of communication control of the UE.

FIG. 7 is an interaction schematic diagram of a communication management method according to an embodiment of the disclosure. The method may be performed by a communication system, which at least includes a server, a first network element and a second network element. As illustrated in FIG. 7, the method may include the following steps.

At step S701, the server sends an information update to the first network element.

The information update includes satellite coverage information and/or a communication parameter for at least one UE, and the communication parameter includes at least one of movement information of the UE or a battery level.

At step S702, the first network element sends the information update to the second network element.

At step S703, the second network element performs communication management on the UE based on satellite coverage information and/or a communication parameter.

The above steps S701-S703 have the same principle as the steps in the embodiments shown in FIGS. 1-6, which may be referred to the related descriptions in FIGS. 1-6, and will not be repeated herein.

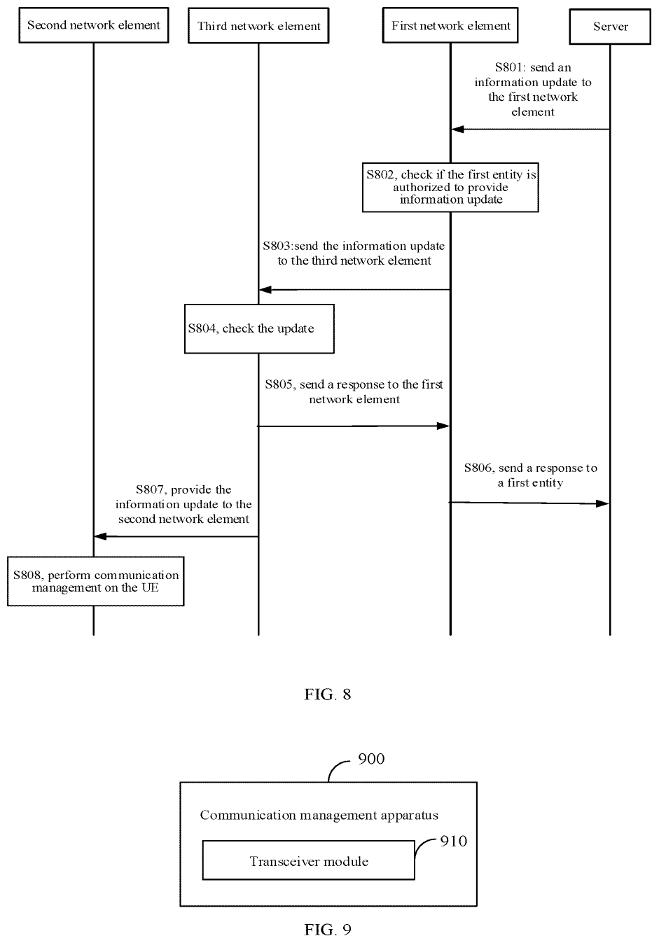

In some embodiments, the communication system may further include a third network element. FIG. 8 is an interaction schematic diagram of a specific communication management method, which includes the following steps.

At step S801, the server sends an information update to the first network element.

Specifically, the SCS/AS sends an update request message to the SCEF, in which the update request message includes a network external identifier of a user, a MSISDN, a network external identifier of a user group, an SCS/AS identifier, a communication parameter set identifier, or satellite coverage information. The communication parameter at least includes movement information of the UE or a battery level, and validity time(s) corresponding to the satellite coverage information and/or the communication parameter.

At step S802, the first network element checks whether the server is authorized to provide the information update.

Specifically, the SCEF checks whether the SCS/AS is authorized to send the satellite coverage information and/or communication update request to the UE or each UE in a UE group. The SCEF may add/modify/delete the satellite coverage information and/or the communication parameter according to an operator policy or a configuration.

At step S803, the first network element sends the information update to the third network element.

Specifically, the SCEF sends a satellite coverage information and/or communication parameter update request to the HSS, in which the request includes a network external identifier of a user, a MSISDN, a network external identifier of a user group, an SCEF reference ID, an SCEF address, a communication parameter set, satellite coverage information, and a validity time, and is configured for sending the satellite coverage information and/or the communication parameter set corresponding to each UE. The SCEF generates, based on the communication parameter set identifier obtained from the SCS/AS, the SCEF reference ID for the corresponding communication parameter set.

At step S804, the third network element checks the update.

Specifically, the HSS checks the satellite coverage information and/or communication parameter update request message, for example, checking whether the network external identifier of the user or the MISSN or the network external identifier of the user group exists. In a case where the checking fails, the HSS sends an update failure message to the SCEF. The HSS performs a conversion between the network external identifier of the user or the MISSN with an IMSI, or resolves the network external identifier of the user group into an IMSI of each user in the user group and stores the satellite coverage information and/or the communication parameter set and its validity time in UE subscription data corresponding to the IMSI, so that when the serving MME changes as the UE moves, the latest serving MME may obtain the satellite coverage information and/or the communication parameter set.

When the HSS determines that the stored satellite coverage information and/or the communication parameter set of a given UE needs to be modified, when the SCEF reference ID associated with the satellite coverage information and/or the communication parameter set to be stored matches the SCEF reference ID associated with the satellite coverage information and/or the communication parameter set already stored on the HSS, it is necessary to delete the stored satellite coverage information and/or the communication parameter set and store the new satellite coverage information and/or the communication parameter set and corresponding validity time(s).

When the satellite coverage information and/or the communication parameter set need(s) to be deleted, the HSS deletes the satellite coverage information and/or the communication parameter set from the subscription information. When the validity time(s) of the satellite coverage information and/or the communication parameter set stored in the HSS expires, the HSS will automatically delete the associated satellite coverage information and/or the communication parameter set with no additional signaling.

At step S805, the third network element sends a response to the first network element.

Specifically, the HSS sends a satellite coverage information and/or communication parameter update response to the SCEF, which includes an SCEF reference ID and a cause value. The cause value indicates a successful update of subscription information, or a reason for a fail update of subscription information.

At step S806, the first network element sends a response to the server.

Specifically, the SCEF sends an update response to the AS, the update response including the satellite coverage information and/or the communication parameter set identifier and the cause value, to inform the SCS/AS whether the communication parameter set has been updated successfully.

At step S807, the third network element provides the information update to the second network element.

Specifically, the HSS initiates a corresponding subscription data insertion process for each UE in a UE group, and sends the satellite coverage information, the communication parameter set, the validity time, the SCEF reference ID, etc. to the MM.

When the MME determines that the stored satellite coverage information and/or the UE communication parameter set need(s) to be modified, when the SCEF reference ID associated with the satellite coverage information and/or the communication parameter set to be stored matches the SCEF reference ID associated with the satellite coverage information and/or the communication parameter set stored on the HSS, it is necessary to delete the stored satellite coverage information and/or the communication parameter set from the corresponding UE context and store the new satellite coverage information and/or the communication parameter set and corresponding validity time(s).

At step S808, the second network element performs communication management on the UE.

Specifically, the MME stores the new satellite coverage information and/or the communication parameter set, and the corresponding SCEF reference ID and the validity time(s). The MME may perform communication management according to the satellite coverage information and/or the communication parameter set, such as the following operations:
setting a PSM and eDRX parameter according to the satellite coverage information and/or the communication parameter;
in a case of the UE using a satellite access with discontinuous coverage, providing the satellite coverage information for the UE; and
in a case of the UE using a satellite access with discontinuous coverage, when the UE is out of coverage, it is determined that the UE remains in no service, or the UE is indicated to use other available access.

In addition, when the satellite coverage information and/or the communication parameter set need(s) to be deleted, the MME deletes the satellite coverage information and/or the communication parameter set from the subscription data. When the validity time(s) of the satellite coverage information and/or the communication parameter set stored in the MME expires, the MME automatically deletes the associated satellite coverage information and/or the communication parameter set with no additional signaling.

In conclusion, according to the communication management method provided by the disclosure, the server sends the information update to the first network element. The information update includes the satellite coverage information and/or the communication parameter for at least one UE, and the communication parameter includes at least one of the movement information of the UE or the battery level. The first network element sends the information update to the second network element, and the second network element performs the communication management on the UE based on the satellite coverage information and/or the communication parameter. Through the scheme in this disclosure, the AS is enabled to provide the satellite coverage information, the UE movement information or the UE battery level to the core network through the SCEF, and the network performs the communication management and control for the UE based on those information, thus improving a flexibility of communication control of the UE.

In the above embodiments of the disclosure, the methods provided by the embodiments of the disclosure are introduced from the perspectives of the server, the first network element and the second network element respectively. In order to realize the functions in the methods provided by the embodiments of the disclosure, the server, the first network element and the second network element may include a hardware structure and a software module, and the above functions are realized in the form of the hardware structure, the software module, or a combination of the hardware structure and the software module. A certain function of the above functions may be implemented in a hardware structure, a software module, or a combination of the hardware structure and the software module.

Corresponding to the communication management methods provided in the above embodiments, the disclosure also provides communication management apparatuses. Since the communication management apparatuses provided in the embodiments of the disclosure correspond to the communication management methods provided in the above embodiments, the implementations of the communication management methods are also applicable to the communication management apparatuses provided in the embodiments, and will not be described in detail in the following embodiments.

FIG. 9 is a schematic diagram of a communication management apparatus 900 provided by an embodiment of the disclosure. The communication management apparatus 900 is applied to a server.

As illustrated in FIG. 9, the apparatus 900 includes: a transceiver module 910, configured to send an information update to a first network element, in which the information update includes satellite coverage information and/or a communication parameter for at least one UE, the communication parameter includes at least one of movement information of the UE or a battery level, and the satellite coverage information and/or the communication parameter may be configured to assist a network in performing communication management on the UE.

According to the communication management apparatus provided by the disclosure, the server may send the information update to the first network element. The information update includes the satellite coverage information and/or the communication parameter for at least one UE, the communication parameter includes at least one of the movement information of the UE or the battery level, and the satellite coverage information and/or the communication parameter may be configured to assist the network in performing the communication management on the UE. Through the scheme in this disclosure, the AS is enabled to provide the satellite coverage information, the UE movement information or the UE battery level to the core network through the SCEF, and the network performs the communication management and control on the UE based on those information, thus improving a flexibility of communication control of the UE.

In some embodiments, the information update further includes validity time information, the validity time information is configured for indicating a validity time of at least one of the satellite coverage information, the movement information and the battery level.

In some embodiments, the information update includes the satellite coverage information and/or a communication parameter set for a plurality of UEs.

In some embodiments, the transceiver module 910 is further configured to: receive a subscription request sent by the first network element.

In some embodiments, the transceiver module 910 is further configured to: in response to the subscription request, send the information update to the first network element.

In some embodiments, the UE movement information includes at least one of: a moving trajectory of the UE; a moving velocity of the UE; or a time when the UE is at a certain location on a moving trajectory.

In some embodiments, the satellite coverage information includes at least one of: ephemeris information and/or satellite trajectory information of a satellite access network, in which the satellite access network includes an available satellite access network or a satellite access network currently used by the UE; or satellite coverage information of a UE location, in which the satellite coverage information indicates satellite signal coverage information of the UE location, the satellite signal coverage information includes at least one of a signal coverage time, a signal coverage duration, a time without signal coverage or a duration without signal coverage, and the UE location includes a current location of the UE or a location of the UE on a moving trajectory.

In conclusion, according to the communication management apparatus provided by the disclosure, in response to the subscription of the first network element, the server may send the information update to the first network element. The information update includes the satellite coverage information and/or the communication parameter for at least one UE, the communication parameter includes at least one of the movement information of the UE or the battery level, and the satellite coverage information and/or the communication parameter may be configured to assist the network in performing communication management on the UE. Through the scheme of the disclosure, the AS is enabled to, in response to the subscription of the network, provide the satellite coverage information, the UE movement information or the UE battery level to the core network through the SCEF, and the network performs communication management and control for the UE based on those information, thus enhancing the flexibility of communication control of the UE.

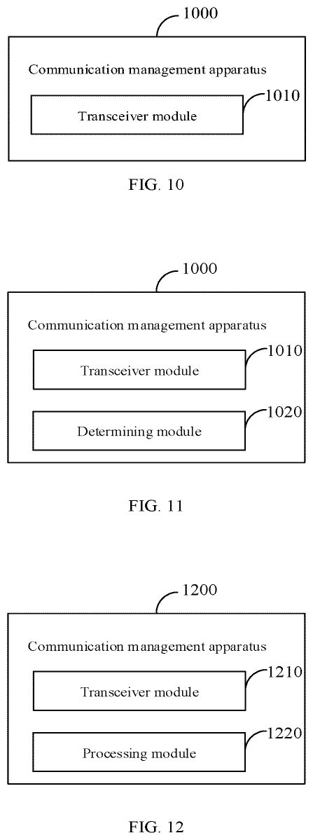

FIG. 10 is a schematic diagram of a communication management apparatus 1000 provided by an embodiment of the disclosure. The communication management apparatus 1000 is applied to a first network element.

As illustrated in FIG. 10, the apparatus 1000 includes: a transceiver module 1010, in which the transceiver module 1010 is configured to: receive an information update sent by a server, in which the information update includes satellite coverage information and/or a communication parameter for at least one UE, and the communication parameter includes at least one of movement information of the UE or a battery level; and send the information update to a second network element, in which the satellite coverage information and/or the communication parameter may be configured to assist a network in performing communication management on the UE.

According to the communication management apparatus provided by the disclosure, the first network element receives the information update sent by the server and sends the information update to the second network element, in which the information update includes the satellite coverage information and/or the communication parameter for at least one UE, the communication parameters include at least one of movement information of the UE or the battery level, and the satellite coverage information and/or the communication parameter may be configured to assist the network to perform the communication management on the UE. The network may thus realize the communication management and control of the UE based on the information update. Through the scheme in this disclosure, the AS is enabled to provide the satellite coverage information, the UE movement information or the UE battery level to the core network through the SCEF, and the network performs the communication management and control on the UE based on those information, thus improving the flexibility of communication control of the UE.

In some embodiments, as illustrated in FIG. 11, the apparatus 1000 further includes: a determining module 1020, configured to determine whether the server is authorized to send the satellite coverage information and/or the communication parameter before sending the information update to the second network element; and in response to determining that the server is authorized, perform an update operation on the satellite coverage information and/or the communication parameter, in which the update operation includes at least one of an adding operation, a modifying operation or a deleting operation.

In some embodiments, the transceiver module 1010 is further configured to: send the satellite coverage information and/or the communication parameter to a third network element, through which the satellite coverage information and/or the communication parameter may be provided to the second network element by the third network element.

In some embodiments, the transceiver module 1010 is further configured to: receive a subscription request sent by the third network element, in which the subscription request is configured for subscribing to the satellite coverage information and/or the communication parameter; and in response to the subscription request, initiate a subscription to the server.

According to the communication management apparatus provided by the disclosure, the first network element receives the information update sent by the server in response to the subscription of the network, authenticates the server and sends the information update to the second network element. The information update includes satellite coverage information and/or a communication parameters for at least one UE, and the communication parameter includes at least one of the movement information of the UE or the battery level, and the satellite coverage information and/or the communication parameter may be configured to assist the network to perform the communication management on the UE. The network may thus realize the communication management and control of the UE based on the information update. Through the scheme in this disclosure, the AS is enabled to provide the satellite coverage information, the UE movement information or the UE battery level to the core network through the SCEF, and the network performs the communication management and control on the UE based on those information, thus improving the flexibility of communication control of the UE.

FIG. 12 is a schematic diagram of a communication management apparatus 1200 provided by an embodiment of the disclosure. The communication management apparatus 1200 is applied to a second network element.

As illustrated in FIG. 12, the apparatus 1200 includes: a transceiver module 1210, configured to receive an information update sent by a first network element, in which the information update includes satellite coverage information and/or a communication parameter for at least one UE, and the communication parameter includes at least one of movement information of the UE or a battery level; and a processing module 1220, configured to perform communication management on the UE based on the satellite coverage information and/or the communication parameter.

According to the communication management apparatus provided by the disclosure, the second network element may receive the information update from the first network element, and perform the communication management on the UE based on the information update. The information update includes the satellite coverage information and/or the communication parameter for at least one UE, and the communication parameter includes at least one of the movement information of the UE or the UE battery level. Based on the satellite coverage information and/or the communication parameter, the communication management is performed on the UE. In this way, the network may perform the communication management and control on the UE based on the information update. Through the scheme in this disclosure, the AS is enabled to provide the satellite coverage information, the UE movement information or the UE battery level to the core network through the SCEF, and the network performs the communication management and control on the UE based on those information, thus improving the flexibility of communication control of the UE.

In some embodiments, when the communication parameter includes the movement information, the processing module 1220 is further configured to: in a case of the UE using satellite access with discontinuous coverage, provide the satellite coverage information for the UE; and/or, in a case of the UE being out of coverage, determine that the UE remains in no service or indicate the UE to use other available access.

In some embodiments, when the communication parameter includes the UE battery level, the processing module 1220 is further configured to: determine that the UE enters a power saving mode or indicate the UE to use other available access; and in a case of the battery level being lower than a threshold or the UE entering a period without satellite coverage, indicate the UE to enter the power saving mode.

In some embodiments, the processing module 1220 is further configured to: receive the satellite coverage information and/or the communication parameter from a third network element, in which the satellite coverage information and/or the communication parameter may be obtained by the third network element from the first network element.

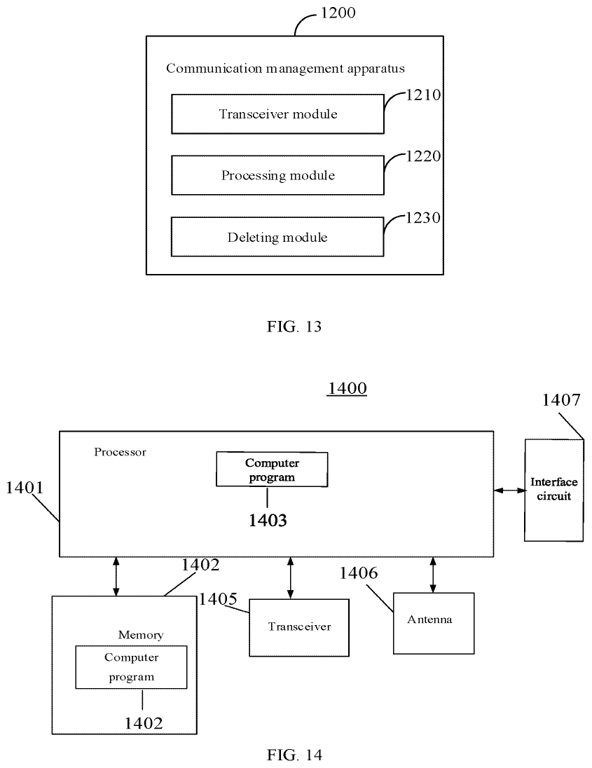

In some embodiments, the information update also includes validity time information corresponding to the satellite coverage information and/or the communication parameter, the validity time information is configured to indicate a validity time of the movement information or the battery level. As illustrated in FIG. 13, the apparatus 1200 further includes: a deleting module 1230, configured to, in a case of the validity time expiring, automatically delete the corresponding satellite coverage information and/or the communication parameter.

In some embodiments, the transceiver module 1210 is further configured to: send a subscription request to the third network element, in which the subscription request is configured to subscribe to the satellite coverage information and/or the communication parameter.

According to the communication management apparatus provided by the disclosure, the second network element may perform a parameter subscription on the third network element, and the third network element obtains the corresponding parameter, which may be subscribed by the third network element to the first network element or sent by the first network element autonomously. Correspondingly, the first network element obtains the corresponding parameter, which may be subscribed by the first network element to the server or sent by the server autonomously. The server may realize the communication management and control on at least one UE based on the information update. Through the scheme in this disclosure, the AS is enabled to provide the satellite coverage information, the UE movement information or the UE battery level to the core network through the SCEF, and the network performs the communication management and control on the UE based on those information, thus improving the flexibility of communication control of the UE.

The embodiment of the disclosure also provides a communication system, which includes a server, a first network element and a second network element.

The server sends an information update to the first network element, in which the information update includes satellite coverage information and/or a communication parameter for at least one UE, and the communication parameter includes at least one of movement information of the UE or a battery level.

The first network element sends the information update to the second network element.

The second network element performs communication management on the UE based on the satellite coverage information and/or the communication parameter.

In conclusion, according to the communication management method provided by the disclosure, the server sends the information update to the first network element. The information update includes the satellite coverage information and/or the communication parameter for at least one UE, and the communication parameter includes at least one of the movement information of the UE or the battery level. The first network element sends the information update to the second network element. The second network element performs the communication management on the UE based on the satellite coverage information and/or the communication parameter. Through the scheme of the disclosure, the AS is enabled to provide the satellite coverage information and/or the UE movement information or the UE battery level to the core network through the SCEF, and the network may perform the communication management and control on the UE based on those information, thereby enhancing the flexibility of communication control of the UE.

As illustrated in FIG. 14, FIG. 14 is a schematic diagram of a communication apparatus 1400 according to an embodiment of the disclosure. The communication apparatus 1400 may be a network device, a UE, or a chip, a chip system or a processor that supports the network device to realize the above methods, or a chip, a chip system or a processor that supports the UE to realize the above methods. The device may be used to realize the methods described in the above method embodiments with reference to the description of the above method embodiments.

The communication apparatus 1400 may include one or more processors 1401. The processor 1401 may be a general purpose processor or a dedicated processor, such as, a baseband processor or a central processor. The baseband processor is used for processing communication protocols and communication data. The central processor is used for controlling the communication apparatus (e.g., base station, baseband chip, terminal, terminal chip, central unit (CU) and distributed unit (DU)), executing computer programs, and processing data of the computer programs.

In some embodiments, the communication apparatus 1400 may include one or more memories 1402 on which computer programs 1404 are stored. The processor 1401 executes the computer programs 1404 to cause the communication apparatus 1400 to perform the methods described in the above method embodiments. In some embodiments, the memory 1402 may also store data. The communication apparatus 1400 and the memory 1402 may be set separately or integrated together.

In some embodiments, the communication apparatus 1400 may also include a transceiver 1405 and an antenna 1406. The transceiver 1405 may be referred to as transceiver unit, transceiver machine, or transceiver circuit, for realizing the transceiver function. The transceiver 1405 may include a receiver and a transmitter. The receiver may be referred to as receiver machine or receiving circuit, for realizing the receiving function. The transmitter may be referred to as transmitter machine or transmitting circuit, for realizing the transmitting function.

In some embodiments, the communication apparatus 1400 may also include one or more interface circuits 1407. The interface circuits 1407 are used to receive code instructions and transmit them to the processor 1401. The processor 1401 runs the code instructions to cause the communication apparatus 1400 to perform the method described in the method embodiments.

In an implementation, the processor 1401 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1401 stores a computer program 1403. When the computer program 1403 runs on the processor 1401, the communication apparatus 1400 is caused to perform the method described in the above method embodiments. The computer program 1403 may be solidified in the processor 1401, in which case the processor 1401 may be implemented by hardware.

In an implementation, the communication apparatus 1400 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on. a network device or a UE, but the scope of the communication apparatus described in the disclosure is not limited thereto, and the structure of the communication apparatus is not limited by FIG. 14. The communication apparatus may be a stand-alone device or may be part of a larger device. For example, the communication apparatus may be:
(1) a stand-alone IC, chip, chip system or subsystem;
(2) a collection of ICs including one or more ICs, in some embodiments, the collection of ICs may also include a storage component for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

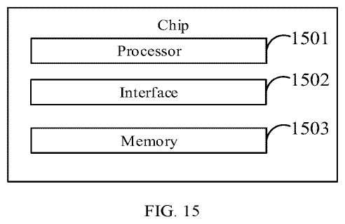

The case where the communication apparatus may be a chip or a chip system may be referred to the schematic diagram of a chip shown in FIG. 15. In FIG. 15, the chip includes a processor 1501 and an interface 1502. There may be one or more processors 1501, and there may be a plurality of interfaces 1502.

In some embodiments, the chip further includes a memory 1503 used for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs)) or wirelessly (e.g., by using infrared wave, wireless wave, or microwave). The computer-readable storage medium may be any usable medium to which the computer has access or a data storage device such as a server and a data center integrated by one or more usable mediums. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using “first”, “second”, and “third”, and “A”, “B”, “C” and “D” do not indicate any order of precedence or magnitude.

As used herein, the terms “machine-readable medium” and “computer-readable medium” refer to any computer program product, device, and/or equipment (e.g., magnetic disk, optical disk, memory, programmable logic device (PLD)) for providing machine instructions and/or data to a programmable processor, which includes a machine-readable medium that receives machine instructions as machine-readable signals. The term “machine-readable signal” refers to any signal used to provide machine instructions and/or data to a programmable processor.

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, middleware components, or front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other.

It is understandable that the steps may be reordered, added or deleted using various forms of processes shown above. For example, the steps in the disclosure may be performed in parallel, sequentially or in different orders, as long as the desired results of the technical solutions disclosed in the disclosure are achieved, which are not limited herein.

In addition, it should be understood that the embodiments of the disclosure may be implemented separately or in combination with other embodiments if it is allowed by the disclosure.

Those skilled in the art may realize that the units and algorithmic steps of the various examples described in combination with the embodiments of the disclosure disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the art that for convenience and conciseness of description, the specific working processes of the systems, devices and units described above can refer to the corresponding processes in the aforementioned method embodiments, and will not be repeated here.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A communication management method, performed by a server, comprising:
sending an information update to a first network element, wherein the information update comprises at least one of satellite coverage information or a communication parameter for at least one user equipment (UE),
wherein the communication parameter comprises at least one of movement information of the UE or a battery level, and at least one of the satellite coverage information or the communication parameter is configured to assist a network in performing communication management on the UE.

2. The method of claim 1, wherein the information update further comprises validity time information, the validity time information is configured for indicating a validity time of at least one of the satellite coverage information, the movement information or the battery level.

3. The method of claim 1, further comprising:
receiving a subscription request sent by the first network element.

4. The method of claim 1, wherein the movement information of the UE comprises at least one of:
a moving trajectory of the UE;
a moving velocity of the UE; or
a time when the UE is at a certain location on a moving trajectory.

5. The method of claim 1, wherein the satellite coverage information comprises at least one of:
at least one of ephemeris information or satellite trajectory information of a satellite access network, wherein the satellite access network comprises an available satellite access network or a satellite access network used currently by the UE; or
satellite coverage information of a UE location, wherein the satellite coverage information indicates satellite signal coverage information of the UE location, the satellite signal coverage information comprises at least one of a signal coverage time, a signal coverage duration, a time without signal coverage or a duration without signal coverage, and the UE location comprises a current location of the UE or a location of the UE on a moving trajectory.

6. A communication management method, performed by a first network element, comprising:
receiving an information update sent by a server, wherein the information update comprises at least one of satellite coverage information or a communication parameter for at least one user equipment (UE), and the communication parameter comprises at least one of movement information of the UE or a battery level; and
sending the information update to a second network element, wherein at least one of the satellite coverage information or the communication parameter is configured to assist a network in performing communication management on the UE.

7. The method of claim 6, further comprising:
determining whether the server is authorized to send at least one of the satellite coverage information or the communication parameter; and
in response to determining that the server is authorized, performing an update operation on at least one of the satellite coverage information or the communication parameter, wherein the update operation comprises at least one of an adding operation, a modifying operation or a deleting operation.

8. The method of claim 6, further comprising:
receiving a subscription request sent by a third network element, wherein the subscription request is configured for subscribing to at least one of the satellite coverage information or the communication parameter; and
initiating the subscription request to the server.

9. A communication management method, performed by a second network element, comprising:
receiving an information update sent by a first network element, wherein the information update comprises at least one of satellite coverage information or a communication parameter for at least one user equipment (UE), and the communication parameter comprises at least one of movement information of the UE or a battery level; and
performing communication management on the UE based on at least one of the satellite coverage information or the communication parameter.

10. The method of claim 9, wherein in a case of the communication parameter comprising the movement information, performing the communication management based on at least one of the satellite coverage information or the communication parameter, comprises at least one of:
in a case of the UE using satellite access with discontinuous coverage, providing the satellite coverage information for the UE; or,
in a case of the UE being out of coverage, determining that the UE remains in no service or indicating the UE to use other available access.

11. The method of claim 9, wherein in a case of the communication parameter comprising the battery level, performing the communication management based on at least one of the satellite coverage information or the communication parameter, comprises:
determining that the UE enters a power saving mode or indicating the UE to use other available access; and
in a case of the battery level being lower than a threshold or the UE entering a period without satellite coverage, indicating the UE to enter the power saving mode.

12. The method of claim 9, wherein receiving the information update sent by the first network element, comprises:
receiving at least one of the satellite coverage information or the communication parameter from a third network element.

13. The method of claim 9, wherein the information update further comprises validity time information corresponding to at least one of the satellite coverage information or the communication parameter, the validity time information is configured to indicate a validity time of at least one of the satellite coverage information, the movement information or the battery level, and the method further comprises:
in a case of the validity time expiring, automatically deleting at least one of the corresponding satellite coverage information or the communication parameter.

14. The method of 9, further comprising:
sending a subscription request to a third network element, wherein the subscription request is configured for subscribing to at least one of the satellite coverage information or the communication parameter.

15-17. (canceled)

18. A server communication comprising: a processor, and a memory for storing a computer program, when the processor executes the computer program, the processor is configured to implement the method of claim 1.

19. A non-transitory computer-readable storage medium storing computer-executable instructions, wherein when the computer-executable instructions are executed by a processor, the method of claim 1 is implemented.

20-21. (canceled)

22. A first network element, comprising: a processor and a memory for storing a computer program, when the processor executes the computer program, the processor is configured to implement the method of claim 7.

23. A second network element, comprising: a processor and a memory for storing a computer program, when the processor executes the computer program, the processor is configured to implement the method of claim 9.

24. A non-transitory computer-readable storage medium storing computer-executable instructions, wherein when the computer-executable instructions are executed by a processor, the method of claim 6 is implemented.

25. A non-transitory computer-readable storage medium storing computer-executable instructions, wherein when the computer-executable instructions are executed by a processor, the method of claim 9 is implemented.
